(19) United States
(12) Patent Application Publication
(10) Pub. No.: US 2005/0236749 A1
(43) Pub. Date: Oct. 27, 2005

(54) Cover assembly for a pneumatic spring

(75) Inventors: Alexander Gross, Bischofsheim (DE); Holger Gubitz, Schweinfurt (DE); Thomas Nowotka, Ebelsbach (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/112,302

(22) Filed: Apr. 22, 2005

(30) Foreign Application Priority Data
Apr. 22, 2004 (DE) 10 2004 020 207.9
Jul. 1, 2004 (DE) 10 2004 031 875.1

(51) Int. Cl. F16F 5/00

(52) U.S. Cl. 267/122

(57) ABSTRACT

A cover assembly for a pneumatic spring having a rolling bellows includes an inner cover part having a radially outward facing clamping surface, and an outer cover part having a radially inward facing clamping surface. One of the clamping surfaces is radially elastic and exerts a pretensioning force on a bellows clamped between the clamping surfaces.

### BACKGROUND OF THE INVENTION

1. Field of the Invention

The invention pertains to a cover assembly for a pneumatic spring having a rolling bellows, the assembly including an inner cover part having a radially outward facing clamping surface, and an outer cover part having a radially inward facing clamping surface.

2. Description of the Related Art

DE 40 04 451 A1 describes a rolling bellows for a pneumatic spring. The pneumatic spring has a two-part cover. An inner cover has a conical lateral surface, against which the rolling bellows rests. Several blind threaded holes are machined into the inner cover. After final assembly, the inside lateral surface, also conical, of an outer cover rests on the outside surface of the end of the rolling bellows. Screws pass through the outer cover and can be screwed into the blind holes to hold the end of the rolling bellows nonpositively in place. In addition, a positive connection is present between a groove in the rolling bellows and a ring-shaped projection on the outer cover. This cover design seems expensive and is also very large because its walls must be quite thick to accommodate the blind threaded holes, which also means that there is a loss, under certain conditions, of usable spring space inside the pneumatic spring.

### SUMMARY OF THE INVENTION

The object of the present invention is to improve the cover for a pneumatic spring in such a way as to obtain a simple cover and also to provide the maximum possible spring space for the pneumatic spring.

According to the invention, at least one of the cover parts is radially elastic with respect to the other cover part and after final assembly exerts a pretensioning force on the rolling bellows.

In another advantageous embodiment, the pressure inside the pneumatic spring acts on the back of the clamping surface of the inner cover. The intrinsic tension and the retaining force which thus acts on the rolling bellows can therefore be increased by the additional retaining force exerted by the pressure inside the pneumatic spring.

According to a preferred embodiment, the inner cover is made of plastic. A plastic cover saves weight and can also be made into complicated shapes at low manufacturing cost.

The clamping surface of the inner cover is located on a segmented, circumferential clamping ring. The wall thickness of the clamping ring can be decreased to achieve greater radial mobility.

To obtain a further increase in the retaining forces acting on the rolling bellows, the clamping surface is provided with a tension-locking profile for the rolling bellows. Thus, the more tensile force on the bellows, the better it is gripped.

It is also provided that gaps between the segments of the clamping ring are filled with an elastomeric filler material. This feature ensures that the internal pressure will be able to reinforce the retaining force while allowing the segments to remain mobile in the radial direction.

The outer cover and the inner cover are held together by pins. This pin-type connection can be secured by at least one radially elastic snap element. Alternatively, the inner cover and the outer cover can be welded together.

A ring seal is also provided between the inner cover and the outer cover. This ring seal prevents pressure from being lost through the pin-type connection. In addition, this round sealing principle prevents the operating pressure of the pneumatic spring from acting on the end surface of the bellows, which could cause the bellows to delaminate. For cost reasons, the ring seal and the filler between the segments are made as a one-piece unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a cross-sectional representation through a cover for a pneumatic spring; and

FIG. 2 shows an exploded view of FIG. 1.

### DETAILED DESCRIPTION OF THE PRESENTLY PREFERRED EMBODIMENTS

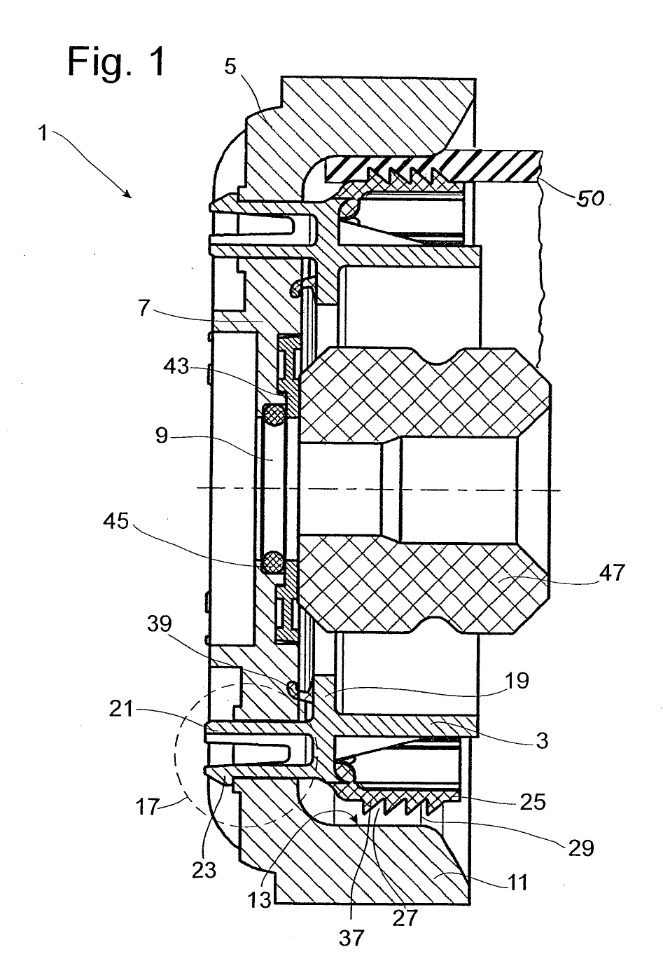

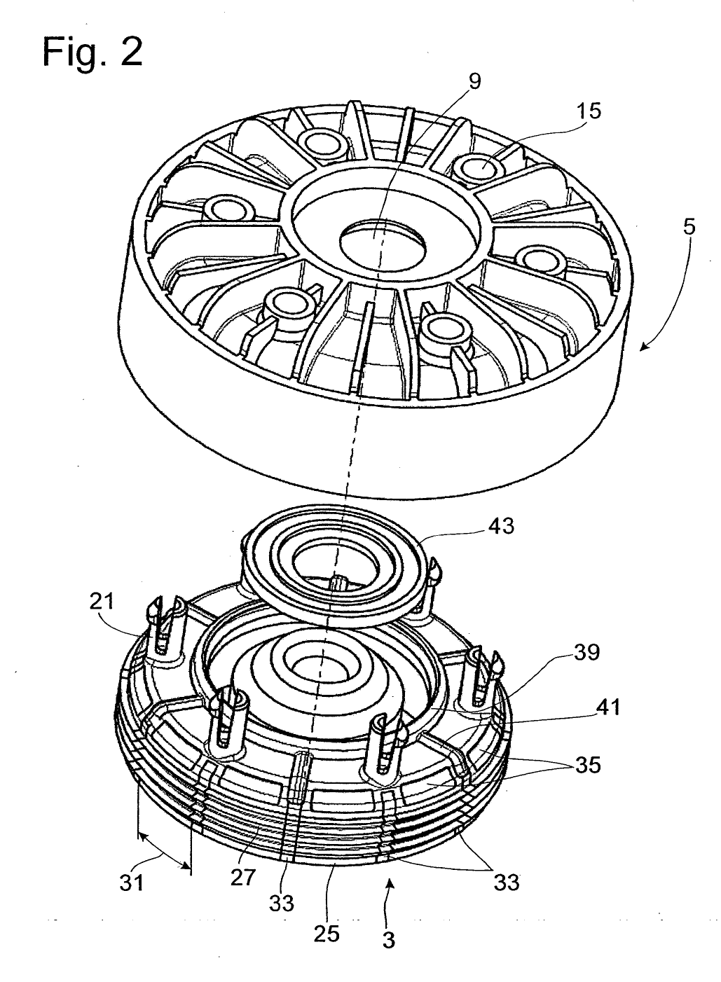

FIG. 1 shows a cover 1 for a pneumatic spring of the type which can be used in motor vehicles, for example. The design of these springs can be assumed as known. The cover 1 consists, among other things, of an inner cover 3 and an outer cover 5. The outer cover 5 has a cup-shaped cross section with a floor 7 in the form of a circular ring, which possibly has a pass-through opening 9 for a piston rod (not shown) of a vibration damper. Adjacent to the bottom in the axial direction is the circumferential clamping edge 11 with a radially inward-facing clamping surface 13. The clamping edge 11 is designed to have the greatest possible dimensional stability. In addition, the floor 7 has a number of openings 15 (see FIG. 2) for the pin-type connections 17 with the inner cover 3. On the inner cover, several pins 21 project from a floor 19; these pins pass through the openings 15 in the outer cover 5; the pin-type connections thus hold the outer cover and the inner cover together. The pin-type connections can also be secured by at least one radially elastic snap element 23, which acts on the top surface of the bottom part 7 of the outer cover. Alternatively, the outer cover 5 and the inner cover 3 can be welded together at the pin-type connections, in which case a mushroom-like head can be formed on the pins 21, which would then rest on the floor 7.

The inner cover 3, which is preferably made of plastic, has a clamping ring 25 with a radially outward-facing clamping surface 27. The inner cover 3 is designed to be elastic in the radial direction in the area of the clamping surface 27 so that, after final assembly, it can exert a pretensioning force on the rolling bellows 50 (shown in part) of the pneumatic spring, the end of which is held in the ring-shaped space 29. The clamping surface 27 of the inner cover 3, as FIG. 2 shows, is divided into segments 31 in the circumferential direction. The circumferential gaps 33 present between the segments 31 are filled with a soft, elastomeric filler material. Additional pockets 35 on the back of the clamping surface 27 provide radial elasticity. In addition, the clamping surface 27 is provided with a tension-locking profile 37 for the rolling bellows.

As can also be seen in FIG. 1, a ring seal 39 is located between the floor 19 of the inner cover 3 and the floor 7 of the outer cover 5; this seal prevents pressure from being lost through the pin-type connections 17. FIG. 2 makes it clear that the ring seal 39 and the filler material in the gaps 33 in the form of radially oriented beads 41 form a single unit, so that the filler and the ring seal can be injected onto the inner cover in a single operation.

If the pneumatic spring is combined with a vibration damper, a ring-shaped seal 45 is also sandwiched between the bottom part 7 and a cover disk 43. The cover disk can be made of a metallic material or of plastic and is secured to the outer cover 5 in any desired way so that it cannot fall out in the axial direction. The cover disk can be followed in turn by a stop buffer 47, which fulfills its function whenever the deflection of the pneumatic spring exceeds a certain value.

During the assembly process, the inner cover 3 is pushed into the rolling bellows 50 of the pneumatic spring until the top surface of the floor 19 is more-or-less aligned with the end of the rolling bellows. If the pneumatic spring is to be combined with a vibration damper and accordingly there is a through-opening 9 present, the outer * cover 5 will be equipped with the ring seal 45, which is secured in place by the cover disk 43. This preassembled unit is placed over the top of the inner cover, and the pins 21 are pushed into the openings 15 until the bottom surface of the floor 7 of the outer cover 5 and the top surface of the floor 19 of the inner cover 3 are in close enough contact to provide sufficient pretension for the ring seal 39. In this position, the snap elements hold everything in place, or the outer cover and the inner cover are welded together. The rolling bellows 50 is now held in place in the ring-shaped space 29 between the clamping surfaces 13 and 27.

When the rolling bellows is filled with compressed air, the pressure will also act on the back of the clamping ring 25 and thus increase the pretension being exerted by the elastic clamping edge. The filler in the gaps 33 prevents compressed air from escaping between the segments 31 and the rolling bellows via the ring-shaped space 29 and the pin-type connections, so that the self-reinforcing, pressure-locking effect is obtained.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A cover assembly for a pneumatic spring having a rolling bellows, the assembly comprising:
an inner cover part having a radially outward facing clamping surface; and
an outer cover part having a radially inward facing clamping surface,
wherein one of said clamping surfaces is radially elastic and exerts a pretensioning force on a bellows clamped between said clamping surfaces.

2. The cover assembly of claim 1 wherein the radially outward facing surface is radially elastic, the radially outward surface being urged radially outward by pressure inside the pneumatic spring.

3. The cover assembly of claim 1 wherein the inner cover is made of plastic.

4. The cover assembly of claim 1 wherein said inner cover comprises a clamping ring which forms said outward facing clamping surface, said clamping ring comprising segments which are separated by circumferential gaps.

5. The cover assembly of claim 4 further comprising an elastomeric filler material in said gaps.

6. The cover assembly of claim 1 wherein said radially elastic clamping surface has a tension-locking profile.

7. The cover assembly of claim 1 wherein said inner cover has a plurality of pins which extend through holes in the outer cover.

8. The cover assembly of claim 7 wherein said pins are provided with latches for securing said covers together in a snap-fit.

9. The cover assembly of claim 1 further comprising a ring seal situated axially between said inner cover and said outer cover.

10. The cover assembly of claim 5 further comprising an elastomeric ring seal situated axially between said inner cover and said outer cover, the ring seal being formed formed integrally with the elastomeric material in the gaps.

11. The cover assembly of claim 1 wherein the inner cover and the outer cover are welded together.
